(19) United States
(12) Patent Application Publication
(10) Pub. No.: US 2010/0234022 A1
(43) Pub. Date: Sep. 16, 2010

(54) SYSTEM AND METHOD FOR SUPL ROAMING IN WIMAX NETWORKS

(75) Inventor: James WINTERBOTTOM, Gwynneville NSW (AU)

Correspondence Address: Duane Morris LLP, 505 9th Street, N.W., Suite 1000, Washington, DC, 20004, US

(73) Assignee: Andrew LLC, Hickory, NC (US)

(21) Appl. No.: 12/404,757

(22) Filed: Mar. 16, 2009

(51) Int. Cl. H04W 8/02; G06F 21/20

(52) U.S. Cl. 455/433; 726/4

(57) ABSTRACT

A system and method for connecting a mobile device to a node in a wireless communications network. A query may be received from a mobile device for a location based application at a visited network having a visited location server. A message including information identifying the visited network may be transmitted from the visited network to a home network in response to the query, the message authenticated by the home network. A secure user plane location start message including serving base station information may be transmitted from the device to the home network. A request using roaming location protocol may then be transmitted from the home location server to the visited location server, the request including the serving base station information, and a location of the serving base station returned from the visited location server to the home location server in response to the request using roaming location protocol.

### BACKGROUND

This disclosure generally relates to location and roaming approaches in GSM, CDMA, and UMTS networks. Further, this disclosure relates to user and control plane location approaches in core networks and GERAN, UTRAN, WiMAX and Complementary Access radio access networks.

Mobile communications infrastructure is typically conceptualized in two generally separate components: the core network (“CN”) and the radio access network (“RAN”). Together, this infrastructure enables user equipment (“UE”), the RAN, and CN to be developed and implemented separately according to the permissive standards set by organizations such as 3GPP and ITEU. Thus, various types of RANs, such as GERAN or UTRAN, can be paired with a single UMTS CN. Also, the UMTS standards provide for protocol separation between data related to user communications and data related to control of the network's various components. For example, within a UMTS mobile communications network, User Plane (“UP”) bearers are responsible for the transfer of user data, including but not limited to voice or application data. Control Plane (“CoP”) bearers handle control signaling and overall resource management.

As mobile networks transition towards 3G and beyond, location services (LCS, applications of which are sometimes referred to as Location Based Services, or LBS) have emerged as a vital service component enabled or provided by wireless communications networks. In addition to providing services conforming to government regulations such as wireless E911, LCS solutions also provide enhanced usability for mobile subscribers and revenue opportunities for network operators and service providers alike.

Position includes geographic coordinates, relative position, and derivatives such as velocity and acceleration. Although the term “position” is sometimes used to denote geographical position of an end-user while “location” is used to refer to the location within the network structure, these terms may often be used interchangeably without causing confusion. Common position measurement types used in mobile positioning or LCS include, but are not limited to, range, proximity, signal strength (such as path loss models or signal strength maps), round trip time, time of arrival, and angle of arrival. Multiple measurements can be combined, sometimes depending on which measurement types are available, to measure position. These combination approaches include, but are not limited to, radial (for example, employing multiple range measurements to solve for best agreement among circular loci), angle (for example, combining range and bearing using signal strength or round trip time), hyperbolic (for example, using multiple time-of-arrival), and real time differencing (for example, determining actual clock offsets between base stations).

Generally, LCS methods are accomplished through CoP or UP methods. CoP Location (“CoPL”) refers to using control signaling within the network to provide location information of the subscriber or UE. UP Location (“UPL”), such as Secure User Plane Location (“SUPL”) uses user data to provide location information. CoPL location approaches include, but are not limited to, Angle-of-Arrival (“AoA”), Observed Time-Difference-of-Arrival (“OTDOA”), Observed-Time-Difference (“OTD”), Enhanced-OTD (“E-OTD”), Assisted Global Positioning System (“A-GPS”), and Assisted Galileo Navigation Satellite System (“A-GNSS”). UPL approaches include, but are not limited to, A-GPS, and A-GNSS, where this position data is communicated over Internet Protocol (“IP”).

There are two established architectures associated with location determination in modem cellular networks. The architectures are Control Plane (“CoP”) and User Plane (“UP”) architectures. Typically location requests are sent to a network through a query gateway function 1. Depending on the network implementation CoP 15 or UP 10 may be used but not a combination of both, as shown in FIG. 1. Note that queries may also come directly from the target device itself rather than via a gateway. Similarly, CoP or UP may be used but not both.

The difference between user plane and control plane, strictly, is that the former uses the communication bearer established with the device in order to communicate measurements. The latter uses the native signaling channels supported by the controlling network elements of the core and access to communicate measurements. As such, CoPL supports A-GPS—it uses control plane signaling interfaces to communicate GPS data to/from the handset. Similarly UPL can conduct E-OTD—the handset takes the timing measurements but it communicates them to the location platform using the data bearer.

UPL has the advantage of not depending on specific access technology to communicate measurement information. CoPL has the advantage that it can access and communicate measurements which may not be available to the device. Current models require network operators to deploy one or the other, CoPL or UPL.

CoPL uses the native signaling plane of the network to establish sessions and communicate messages associated with location requests and to communicate measurements used for determining location. The control plane is the signaling infrastructure used for procedures such as call control, hand-off, registration, and authentication in a mobile network; CoPL uses this same infrastructure for the performing location procedures. CoPL can utilize measurements made by both the control plane network elements as well as the end-user device being located.

FIG. 2A illustrates an exemplary architectural diagram of CoPL. A mobile station or mobile appliance 101 communication with a base transceiver station (“BTS”) 105 via wireless interface Um. A base station controller (“BSC”) 107 manages radio resources including the BTS 105 via an Abis interface. The Abis interface is an open interface completely defined as part of the ETSI specification for GSM and carries the call set up information, including voice channel assignments between the BSC 107 and BTS 105. A mobile switching center/visitor's location register (“MSC/VLR”) 113 coordinates between the mobile appliance communication network and a global mobile location center (“GMLC”) 117.

In operation, a location measurement device (not shown) may be connected to the BSC 107 via the Abis wire line interface and makes measurements on the RF signals of the Um interface, along with other measurements to support one or more of the position methods associated with the CoPL. Measurements from the location measurement units are sent to a servicing mobile location center (“SMLC”) 109 via BCS 107 where the location of an MS 101 can be determined. The BTS 105, BSC 107 and SMLC 109 form a base station subsystem (“BSS”) 103. The GMLC 117 is connected to a home location register (“HLR”) 111 over an Lh interface and the MSC/VLR 113 over an Lg interface. A global mobile switching center (“GMSC”) 115 is operably connected to the MSC/VLR 113.

The operation of a CoPL architecture is shown in FIG. 2B. This shows the 3GPP location services architecture. A gateway mobile location centre (“GMLC”) 117 is the network element that receives the location requests. The GMLC queries the HLR 111 over the Lh interface to find out which part of the access network 107 is currently serving the target device. The GMLC 117 sends a location request to the current serving core network node 113 via the Lg interface. The current serving core network node 113 (e.g., MSC or serving GPRS service node (“SGSN”)) then passes the request to the part of the access network 107 attached to the target device (e.g., GERAN BSC or UTRAN RNC). This access network element 107 then invokes the facilities of the SMLC 109. The location request session between the access network node 107 and the SMLC 109 provides a channel by which the SMLC 109 can ask for network measurements or to send messages to the end-user device 101 so that device measurement information can be exchanged. The SMLC 109 may also obtain location measurement information from external devices 110 such as location measurement units (“LMUs”) which take RF readings from the air interface. Similarly, the device may also take measurements from external systems, such as GPS satellites, and communicate these to the SMLC 109.

Developed as an alternative to CoPL, Secure User Plane Location (“SUPL”) is set of standards managed by the Open Mobile Alliance (“OMA”) to transfer assistance data and positioning data over IP to aid network and terminal-based positioning technologies in ascertaining the position of a SUPL Enabled Terminal (“SET”).

User Plane Location (“UPL”) does not explicitly utilize the control plane infrastructure. Instead UPL assumes that a data bearer plane is available between the location platform and the end-user device. That is, a control plane infrastructure may have been involved in establishing the data bearer so that communication can occur with the device but no location-specific procedural signaling occurs over the control plane. As such, UPL is limited to obtaining measurements directly from the end-user device itself.

SUPL includes a Location User Plan (“Lup”) reference point, the interface between the SUPL Location Platform (“SLP”) and SET, as well as security, authentication, authorization, charging functions, roaming, and privacy functions. For determining position, SUPL generally implements A-GPS, A-GNSS, or similar technology to communicate location data to a designated network node over Internet Protocol (“IP”).

FIG. 3A illustrates an exemplary architectural diagram for SUPL. The illustrated entities represent a group of functions, and not necessarily separate physical devices. In the SUPL architecture, an SLP 201 and SET 207 are provided. The SLP 201 generally includes a SUPL Location Center (“SLC”) 203 and a SUPL Positioning Center (“SPC”) 205. The SLC and SPC optionally communicate over the LIp interface, for instance, when the SLC and SPC are deployed as separate entities. The SET 207 generally includes a mobile location services (“MLS”) application, an application which requests and consumes location information, or a SUPL Agent, a service access point which accesses the network resources to obtain location information.

For any SET, an SLP 201 can perform the role of the home SLP (“H-SLP”), visited SLP (“V-SLP”) or emergency SLP (“E-SLP”). An H-SLP for a SET includes the subscription, authentication, and privacy related data for the SET and is generally associated with a part of the SET's home PLMN. A V-SLP for a SET is an SLP selected by an H-SLP or E-SLP to assist in positioning thereof. An E-SLP for a SET is an SLP associated with or contained in the PLMN serving the SET. The E-SLP may perform positioning in association with emergency services initiated by the SET.

The SLC 203 coordinates operations of SUPL in the network and interacts with the SET over the User Plane bearer to perform various functions including, but not limited to, privacy, initiation, security, roaming, charging, service management, and positioning calculation. The SPC 205 supports various functions including, but not limited to, security, assistance delivery, reference retrieval, and positioning calculation.

SUPL session initiation is network-initiated or SET-initiated. The SUPL architecture provides various alternatives for initiating and facilitating SUPL functions. For example, a SUPL Initiation Function (“SIF”) is optionally initiated using a Wireless Application Protocol Push Proxy Gateway (“WAP PPG”) 211, a Short Message Service Center (“SMSC/MC”) 213, or a User Datagram Protocol/Internet Protocol (“UDP/IP”) 215 core, which forms user plane bearer 220.

The operation of UPL is shown in FIG. 3B. Secure User Plane Location is a standard specification for UPL. Location requests come to the SLP 201 from external applications or from the end-user device itself. If a data session does not exist between the SLP 201 and the device 207 already, then the SLP 201 may initiate a request such that an IP session (user plane bearer 220) is established between the device 207 and the SLP 201. From then on, the SLP 201 may request measurement information from the device 207. The device may also take measurements from the network 107 or from external systems such as GPS 210. Because there is no control plane connectivity to the network, the SLP 201 cannot directly request any measurement information from the network 107 itself. More information on SUPL, including the Secure User Plane Location Architecture documentation (“OMA-AD-SUPL”), can be readily obtained through OMA.

The features of SUPL may be combined with other networks such as, but not limited to, World Interoperability for Microwave Access (“WiMAX”). WiMAX is intended to reduce the barriers to widespread broadband access deployment with standards-compliant wireless solutions engineered to deliver ubiquitous fixed and mobile services such as Voice over IP (“VoIP”), messaging, video, streaming media, and other IP traffic. WiMAX enables delivery of last-mile broadband access without the need for direct line of sight. Ease of installation, wide coverage, and flexibility makes WiMAX suitable for a range of deployments over long-distance and regional networks, in addition to rural or underdeveloped areas where wired and other wireless solutions are not easily deployed and line of sight coverage is not possible.

The original version of the standard on which WiMAX is based (IEEE 802.16) specified a physical layer operating in the 10 to 66 GHz range. 802.16a, updated in 2004 to 802.16-2004, added specifications for the 2 to 11 GHz range. 802.16-2004 was updated by 802.16e-2005 in 2005 and uses scalable orthogonal frequency division multiple access (“SOFDMA”) as opposed to the orthogonal frequency division multiplexing (“OFDM”) version with 256 sub-carriers (of which 200 are used) in 802.16d. More advanced versions, including 802.16e, also bring Multiple Antenna Support through multiple input multiple output (“MIMO”) functionality. This brings potential benefits in terms of coverage, self installation, power consumption, frequency re-use and bandwidth efficiency. Furthermore, 802.16e also adds a capability for full mobility support. Most commercial interest is in the 802.16d and 802.16e standards, since the lower frequencies used in these variants suffer less from inherent signal attenuation and therefore gives improved range and in-building penetration. Already today, a number of networks throughout the world are in commercial operation using WiMAX equipment compliant with the 802.16d standard.

The WiMAX Forum has provided an architecture defining how a WiMAX network connects with other networks, and a variety of other aspects of operating such a network, including address allocation, authentication, etc. It is important to note that a functional architecture may be designed into various hardware configurations rather than fixed configurations. For example, WiMAX architectures according to embodiments of the present subject matter are flexible enough to allow remote/mobile stations of varying scale and functionality and base stations of varying size. The current standards, however, do not explicitly define how home servers determine the address of visited servers. Thus, there is a need in the art to overcome the limitations of the prior art and provide a novel system and method for SUPL roaming in WiMAX networks.

One embodiment of the present subject matter provides a method for connecting a mobile device to a node in a wireless communications network. The method may comprise receiving a query from a mobile device for a location based application at a visited network, the visited network including a visited location server and transmitting a first message from the visited network to a home network in response to the query, the first message including information identifying the visited network and the home network including a home location server. The first message may be authenticated by the home network, and a second message provided to the mobile device in response to the first message. A SUPL start message may then be transmitted from the device to the home network, the SUPL message including serving base station information, and a request transmitted using RLP from the home location server to the visited location server, the request including the serving base station information. A location of the serving base station from the visited location server to the home location server may then be returned in response to the request using RLP.

Another embodiment of the present subject matter provides a method for providing assistance data to a mobile device in a wireless communications network. The method may comprise receiving a query from a mobile device for a location based application at a visited network, the visited network including a visited location server, and transmitting a first message from the visited network to a home network in response to the query, the first message including information identifying the visited network and the home network including a home location server. The first message may be authenticated by the home network, and a second message provided to the mobile device in response to the first message. A SUPL start message may be transmitted to the home network, the SUPL message including serving base station information. The address of the visited location server may be determined by transmitting an Access-Request or equivalent Diameter message from the home location server to a home authentication authorization and accounting (“H-AAA”) server, and transmitting an Access-Accept or equivalent Diameter message from the H-AAA server to the home location server, the Access-Accept or equivalent Diameter message including information regarding the address of the visited location server. A request may then be transmitted from the home location server to the visited location server, the request including serving base station information. A location of the serving base station may then be returned to the home location server in response to the request.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1 is an illustration of a prior art gateway function.

FIG. 2A is an illustration of an exemplary architectural diagram for CoPL.

FIG. 2B is an illustration of the operation of an exemplary CoPL architecture.

FIG. 3A is an illustration of an exemplary architectural diagram for SUPL.

FIG. 3B is an illustration of the operation of an exemplary SUPL architecture.

FIG. 4 is a diagram of an exemplary WiMAX Location Based Service network architecture.

FIG. 5 is a diagram of a call flow according to one embodiment of the present subject matter.

FIG. 6 is an algorithm according to one embodiment of the present subject matter.

FIG. 7 is an algorithm according to another embodiment of the present subject matter.

### DETAILED DESCRIPTION

With reference to the figures where like elements have been given like numerical designations to facilitate an understanding of the present subject matter, the various embodiments of a system and method for SUPL roaming in WiMAX networks are herein described.

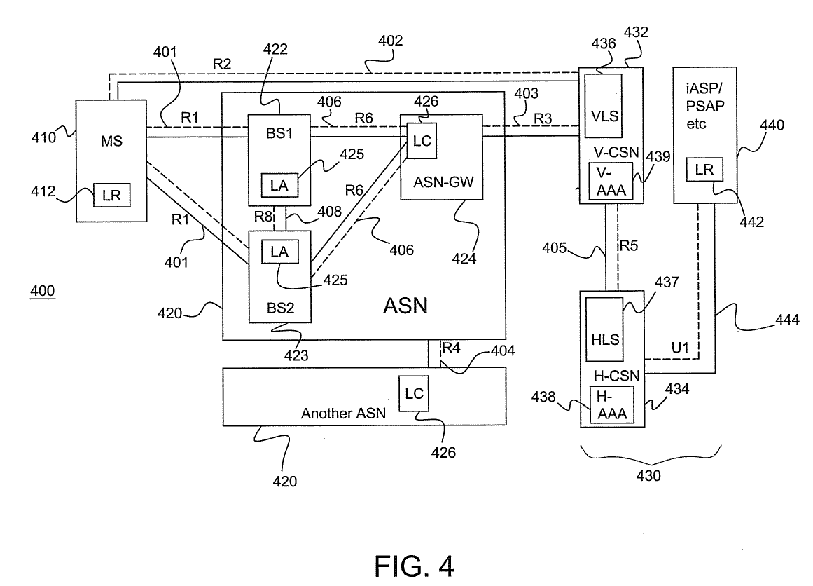

FIG. 4 is a diagram of an exemplary WiMAX Location Based Service (“LBS”) network architecture 400. With reference to FIG. 4, the WiMAX forum defines a number of functional entities and interfaces between those entities. An exemplary network architecture 400 includes one or more access service networks (“ASN”) 420, each having one or more base stations (“BS”) 422, 423 and one or more ASN gateways (“ASN-GW”) 424 forming the radio access network at the edge thereof. One or more mobile stations or devices 410, such as a WiMAX device, having a location requester 412 may be in communication with the ASN 420 via one or more BSs 422, 423 over an R1 interface 401. BSs 422, 423 are responsible for providing the air interface to the MS 410. Additional functions may, of course, be part of BSs 422, 423, such as micromobility management functions, handoff triggering, tunnel establishment, radio resource management, QoS policy enforcement, traffic classification, Dynamic Host Control Protocol (“DHCP”) proxy, key management, session management, and multicast group management, to name a few. BSs 422, 423 communicate with one another via resident location agents (“LA”) 425 over an R8 interface 408. LAs 425 are generally responsible for measurements and reporting and may communicate with the device 410 to collect measurements. BSs 422, 423 also communicate with the ASN-GWs 424 via a location controller (“LC”) 426 in the ASN-GW 424 over an R6 interface 406. LCs 426 generally trigger and collect location measurements and forward these measurements to a location server (“LS”) in a selected connectivity service network (“CSN”) 430.

The ASN-GW 424 generally acts as a layer 2 traffic aggregation point within an ASN 420. Additional functions that may be part of the ASN-GW 424 include, but are not limited to, intra-ASN location management and paging, radio resource management and admission control, caching of subscriber profiles and encryption keys, AAA client functionality, establishment and management of mobility tunnel with BSs, QoS and policy enforcement, foreign agent functionality for mobile IP and routing to a selected CSN. Communication between ASNs 420 occurs over an R4 interface 404. It should also be noted that a Public Safety Answering Point (“PSAP”) or an Internet Application Service Provider (“iASP”) 440 may also include a location requester 442 and may be in communication with a home CSN 434 over a U1 interface 444.

A third portion of the network includes the CSN 430. The CSN may be a visited network having a visited-CSN (“V-CSN”) 432 or a home network having a home-CSN (“H-CSN”) 434, collectively CSNs 430. These CSNs 430 provide IP connectivity and generally all the IP core network functions in the network 400. For example, the CSN 430 provides connectivity to the Internet, ASP, other public networks and corporate networks. The CSN 430 is owned by a network service provider (“NSP”) and includes Authentication Authorization Access (“AAA”) servers (home-AAA 438 and visited-AAA 439 servers) that support authentication for the devices, users, and specific services. Similar to other networks, home and visited AAA servers 438, 439 provide the following core functions in a WiMAX network: Authentication—Confirmation that a user requesting a network service is entitled to do so. This involves presentation of an identity and credentials such as a user name, password, and/or digital certificate. This also requires support for device authentication; Authorization—The granting of specific types of service (or “no service”) to a user based on his/her authentication, the services requested, and the current system state; and Accounting—The tracking of network resource consumption by users. In the WiMAX Forum's NWG Stage 3 Release 1.0.0 specification, AAA is specified as a basic building block. It also includes some functions that are not typically supported in other AAA deployments, such as Wi-Fi. This version of the standard is focused on the use of AAA in Mobile WiMAX, including support for mobile IP. Fixed WiMAX, as well as Wi-Fi, conventionally utilizes RADIUS AAA, Extensible Authentication Protocol (“EAP”), or a custom authentication method. Authorization attributes returned are similar to those returned for common Wi-Fi deployments.

The CSN 430 also provides per user policy management of QoS and security. The CSN 430 is also responsible for IP address management, support for roaming between different NSPs, location management between ASNs 420, and mobility and roaming between ASNs 420, to name a few. Communication between the ASN 420 and a CSN 430 occurs via the respective ASN-GW 424 over an R3 interface 403.

One entity within a CSN 430 is the location server (“LS”) 435. Depending upon whether the device 410 is roaming and in direct communication with a remote network or in direct communication with a home network, the LS may be a visited-LS (“V-LS”) 436 or a home-LS (“H-LS”) 437. The role of the LS is to provide location information about a WiMAX device 410 in the network 400. Communication between the WiMAX device 410 and the LS 436, 437 is performed over an R2 interface 402. The WiMAX forum explicitly allows the use of OMA SUPL 2.0 over the R2 interface 402. WiMAX provides a roaming architecture where a device has a home network but may connect to a network provided by a different operator, such as a visited network.

In this mode of operation two location servers may exist, the H-LS 437 in the home network, and the V-LS 436 in the visited network. The WiMAX forum defines an interface between the H-LS 437 and V-LS 436 called the R5 interface 405. The WiMAX forum, however, does not define how location requests are sent across the R5 interface 405 other than they are RADIUS protocol messages or DIAMETER protocol messages.

RADIUS/DIAMETER capable servers, and thus servers according to embodiments of the present subject matter, may utilize the AAA concept to manage network access. For example, a user or machine (referred to as a RADIUS client) may send a request to a Access Server to gain access to a particular network resource using access credentials. The credentials are passed to the Access Server device via the link-layer protocol.

In turn, the Access Server sends a RADIUS Access Request or equivalent DIAMETER message to the RADIUS server, requesting authorization to grant access via the RADIUS/DIAMETER protocol. This request includes access credentials and may contain information which the Access Server knows about the user, such as its network address or phone number, and information regarding the user's physical point of attachment to the Access Server. The RADIUS/DIAMETER capable server checks that the information is correct using authentication schemes like PAP, CHAP or EAP. The user's proof of identification is verified, along with other information related to the request, such as the user's network address or phone number, account status and specific network service access privileges.

The RADIUS/DIAMETER capable server then returns one of three responses to the Access Server, an Access-Reject, Access-Challenge or Access-Accept (or equivalent DIAMETER message). In an Access-Reject, the user is unconditionally denied access to all requested network resources. Reasons may include failure to provide proof of identification or an unknown or inactive user account. In an Access-Challenge, requests additional information from the user such as a secondary password, PIN, token or card. Access-Challenge is also used in more complex authentication dialogs where a secure tunnel is established between the user machine and the RADIUS Server in a way that the access credentials are hidden from the Access Server. In an Access-Accept, the user is granted access. Once the user is authenticated, the RADIUS server will often check that the user is authorized to use the network service requested. A given user may be allowed to use a company's wireless network, but not its VPN service, for example. This information may be stored locally on the RADIUS server, or may be looked up in an external source like LDAP or Active Directory.

Authorization attributes are conveyed to the Access Server stipulating terms of access to be granted. Exemplary authorization attributes may be, but are not limited to, the specific IP address to be assigned to the user, the address pool from which the user's IP should be chosen, the maximum length that the user may remain connected, an access list, priority queue or other restrictions on a user's access, LSTP parameters, VLAN parameters, QoS parameters, etc.

When network access is granted to the user by the Access Server, an Accounting Start request is sent by the Access Server to the RADIUS capable server to signal the start of the user's network access. “Start” records typically contain the user's identification, network address, point of attachment and a unique session identifier. Periodically, Interim Accounting records may be sent by the Access Server to the RADIUS server, to update it on the status of an active session. “Interim” records typically convey the current session duration and information on current data usage. Finally, when the user's network access is closed, the Access Server issues a final Accounting Stop record to the RADIUS server, providing information on the final usage in terms of time, packets transferred, data transferred, reason for disconnect and other information related to the user's network access. The primary purpose of this data is that the user can be billed accordingly; the data is also commonly used for statistical purposes and for general network monitoring. DIAMETER is another computer networking protocol for AAA and is a successor to RADIUS. The differences between the two are the transport protocols (TCP or SCTP rather than UDP), network or transport level security (Ipsec or TLS), transition support, larger address space for attribute-value pairs (“AVP”) and identifiers (32 bits instead of 8 bits), client-server protocol, both state and stateless models can be used, dynamic discovery of peers, capability negotiation, supports application layer acknowledgements, error notification, roaming support, to name a few.

It should be noted that there are several location determination methods supported by the above-described network architecture 400. For example, a device 410, which is equipped with GPS capability may utilize 802.16m MAC and PHY features to estimate its location when GPS is not available, e.g., indoors, or be able to faster and more accurately acquire GPS signals for location determination. The network 400 may make the GPS assistance data, including GPS Almanac data and Ephemeris data, available through broadcast and/or unicast air interface messages to the device 410. The delivery of GPS assistance data from the network 400 to devices 410 can be realized by enhanced GPS broadcast and/or unicast messages and enhanced LBS management messages. Assisted GPS (“A-GPS”) may also be supported where an integrated GPS receiver and associated network components assist a GPS device to speed up GPS receiver “cold startup” procedure. For example, BSs 422, 423 may provide the device 410 with the GPS Almanac and Ephemeris information downloaded from GPS satellites. By having accurate, surveyed coordinates for the cell site towers, the BSs 422, 423 may also provide better knowledge of ionospheric conditions and other errors affecting the GPS signal than the device 410 alone, enabling more precise calculation of position.

Non-GPS-Based supported methods rely on the role of the serving and neighboring BSs or other components. For example, in a downlink (“DL”) scenario, a device 410 may receive existing signals (e.g., preamble sequence) or new signals designed specifically for the LBS measurements, if it is needed to meet the requirement from the serving/attached BS and multiple neighboring BSs 422, 423. The BSs 422, 423 are able to coordinate transmission of their sequences using different time slots or different OFDM subcarriers. The device 410 accurately calculates the required measurements, even in the presence of multipath channel and heavy interference environment, and then estimates its location accordingly. In an uplink (“UL”) scenario, various approaches may be utilized at the BSs 422, 423 to locate the device. Exemplary measurements are generally supported via existing UL transmissions (e.g., ranging sequence) or new signals designed specifically for the LBS measurements. Exemplary methods may include but are not limited to, TDOA, TOA, RTD, AOA, RSSI, Advanced forward link trilateration (“A-FLT”), Enhanced observed time difference (“EOTD”), Observed time difference of arrival (“OTDOA”), time of arrival (“TOA”), uplink-TOA and uplink-TDOA, Enhanced cell/sector and cell-ID, etc., and hybrid combinations thereof.

The OMA SUPL location architecture is based on the premise that a device 410 has a home network, and all requests for location go through the SUPL server in the home network, i.e., H-LS 437. That is, communication over the R2 interface 402 using SUPL goes between the H-LS 437 and the device 410. The H-LS 437, however, may not be able to provide location information about a device 410 at a remote location (e.g., another continent, etc.), and while SUPL does define the use of roaming location protocol (“RLP”) to broker requests between SUPL servers, SUPL explicitly does not define how the home SUPL server determines the address of the visited SUPL server.

The WiMAX Forum defined an unnamed interface between the visited and home LSs and respective AAA servers. As discussed above, the AAA servers maintain information about how the device 410 is attached to the network 400, and the LSs 436, 437 obtain some of this information by sending the AAA an Access-Request message. The respective AAA may then respond with information about the device in question. If the device is in a visited network, then the AAA in the home network will have information about the visited network, and one of these pieces of information is the identity of the location server in the visited network, the V-LS 436. The use of Roaming Location Protocol (“RLP”) in the place of the R5 interface 405 between the H-LS 437 and the V-LS 436 has not been specified or eluded to by the WiMAX Forum.

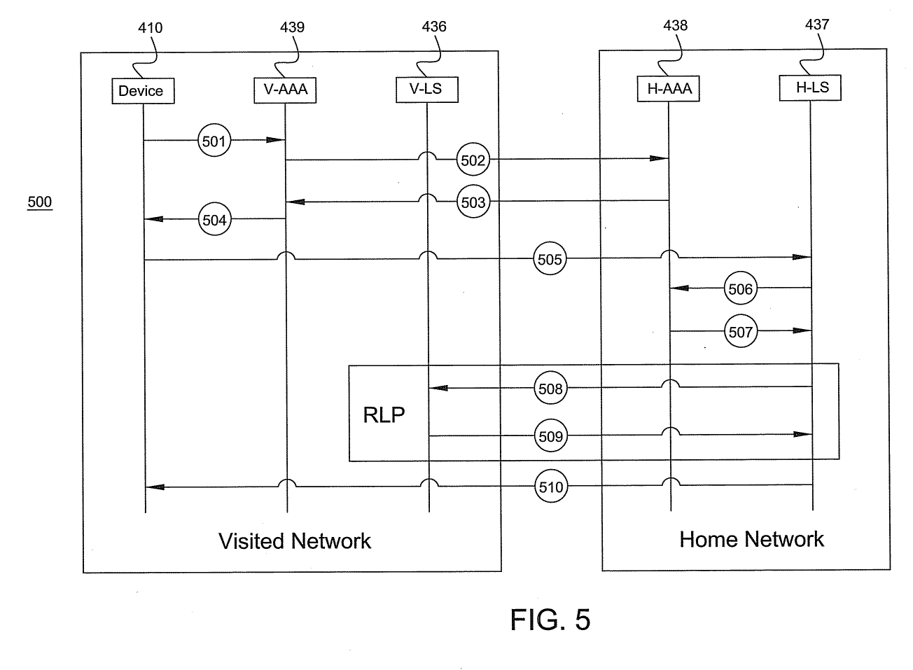

FIG. 5 is a diagram of a call flow 500 for SET-Initiated location according to one embodiment of the present subject matter. With reference to FIGS. 4 and 5, a device 410 may attempt attachment to a respective network 400 and send an Access-Request message to the V-AAA 439 as depicted by step 501. As depicted by step 502, the V-AAA 439 may then ascertain the domain component of the device user-name (e.g., NAI) and identify the H-AAA 438 address. The V-AAA 439 may then include information in the Access-Request message including the V-LS 436 identity and send this to the H-AAA 438. In step 503, the H-AAA 438 authenticates the device 410 and caches the information provided by the V-AAA 439 including the V-LS 436 identity. The H-AAA 438 will then send back an Access-Accept message to the V-AAA 439. At step 504, the V-AAA 439 provides the Access-Accept message to the device 410; and at step 505, the device 410 connects to its home SUPL location platform (“H-SLP”) which acts as the H-LS. The device 410 sends a SUPL-Start message to the H-SLP and includes the serving base station-id in the location id element. At step 506, the H-SLP sends an Access-Request message to the H-AAA 438; and at step 507, the H-AAA 438 responds with an Access-Accept message including the V-LS 436 id, that the H-SLP interprets as the V-SLP identifier. The H-SLP sends a standard roaming location immediate request (“SRLIR”) message to the V-SLP which contains the location id element received from the device 410 at step 508. As depicted by step 509, the V-SLP looks up the serving base station identifier contained in the received location id element, and returns the location of that base station to the H-SLP in a standard roaming location immediate answer (“SRLIA”) message. In one embodiment of the present subject matter steps 508 and 509 occur using RLP. As depicted in step 510, the H-SLP receives the response from the V-SLP, provides assistance data (or the base station location itself) to the device 410, and standard SUPL messaging applies from this point.

It is therefore an aspect of embodiments of the present subject matter to implement SUPL roaming in an exemplary WIMAX network architecture. One aspect of the present subject matter allows an H-SLP to obtain the address of a V-SLP from the AAA server in the home network as it pertains to WiMAX. This information is propagated into the AAA when the MS authenticates with the visited network. The H-SLP may utilize the learned V-SLP address to proxy location requests to the V-SLP for assistance in the location determination process using OMA RLP or MLP as it pertains to WiMAX. Further, the H-SLP may identify the target device or mobile station to the V-SLP in the visited WiMAX network using any one or combination of the following mechanisms, Mobile Station International ISDN Number (“MSISDN”), International Mobile Subscriber Identity (“IMSI”), Mobile Identification Number (“MIN”), Mobile Directory Number (“MDN”), IP version 4 (“IPv4”) address, IP version 6 (“IPv6”) address, telephone uniform resource identifier (“TEL URI”), session initial protocol (“SIP”) URI, session identification (“SESSID”), network address identifier (“NAI”) of the target MS user, etc.

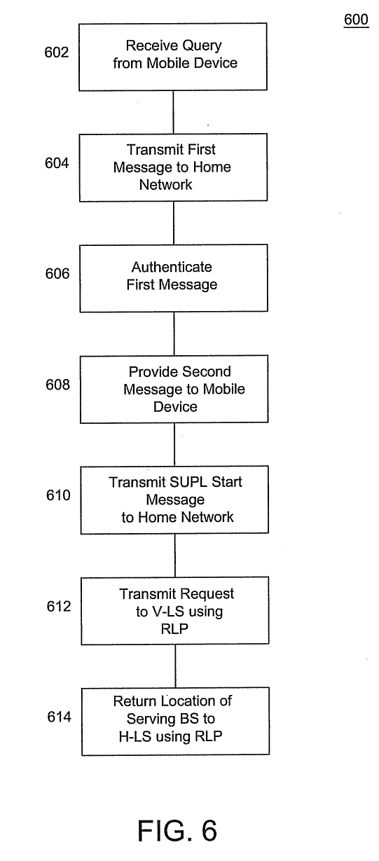

FIG. 6 is an algorithm 600 according to one embodiment of the present subject matter. With reference to FIG. 6, at step 602, a query from a mobile device for a location based application may be received at a visited network, the visited network including a V-LS. An exemplary query may be an Access Request or equivalent Diameter message. An exemplary mobile device may be but is not limited to a cellular device, text messaging device, computer, portable computer, vehicle locating device, vehicle security device, communication device, and wireless transceiver.

A first message may be transmitted from the visited network to a home network in response to the query at step 604, the first message including information identifying the visited network and the home network including an H-LS. In one embodiment, the step of transmitting a message may include includes identifying the home network as a function of a device user name in the query. Further, the identification of the home network may be a H-AAA server address. The first message may be authenticated by the home network at step 606, and a second message provided to the mobile device in response to the first message at step 608. In one embodiment, information in the first message may be cached at the home network. Further, the second message may be an Access Accept or equivalent Diameter message. In another embodiment, the step of providing a second message may include transmitting an Access Accept or equivalent Diameter message from a H-AAA server in the home network to a V-AAA server in the visited network, and relaying the message to the mobile device from the visited network. A SUPL start message may be transmitted from the device to the home network at step 610, the SUPL message including serving base station information. A request using RLP may then be transmitted from the H-LS to the V-LS at step 612, the request including the serving base station information. This request may be a standard roaming location protocol request. A location of the serving base station may be returned from the V-LS to the H-LS in response to the request using RLP at step 614.

The home network may also include an H-AAA server whereby the identification of the visited network may be determined by transmitting an Access-Request or equivalent Diameter message from the home location server to the H-AAA server, and transmitting an Access-Accept or equivalent Diameter message from the H-AAA server to the home location server, the Access-Accept or equivalent Diameter message including information regarding the identity of the visited network. Of course, the visited network may include a V-AAA server. In one embodiment, assistance data may be provided to the mobile device from the H-LS as a function of the location of the serving base station.

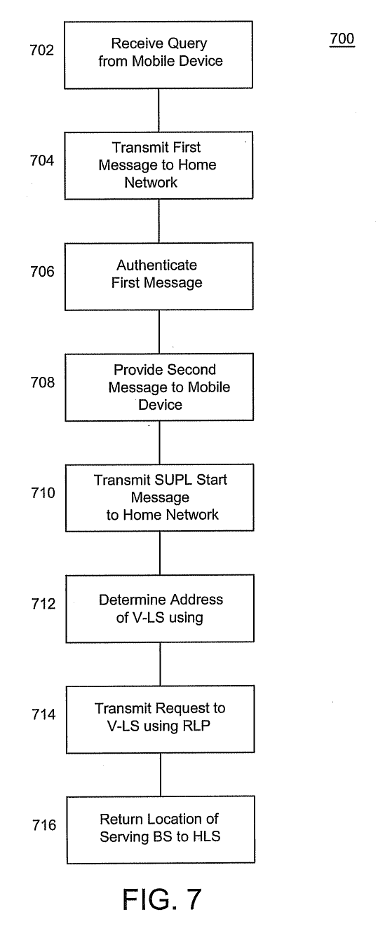

FIG. 7 is an algorithm 700 according to one embodiment of the present subject matter. With reference to FIG. 7, at step 702, a query from a mobile device for a location based application may be received at a visited network, the visited network including a V-LS. An exemplary query may be an Access Request or equivalent Diameter message. An exemplary mobile device may be but is not limited to a cellular device, text messaging device, computer, portable computer, vehicle locating device, vehicle security device, communication device, and wireless transceiver. A first message may be transmitted from the visited network to a home network in response to the query at step 704, the first message including information identifying the visited network and the home network including an H-LS.

In one embodiment, the step of transmitting a message may include includes identifying the home network as a function of a device user name in the query. Further, the identification of the home network may be a H-AAA server address. The first message may be authenticated by the home network at step 706, and a second message provided to the mobile device in response to the first message at step 708. In one embodiment, information in the first message may be cached at the home network. Further, the second message may be an Access Accept or equivalent Diameter message. In another embodiment, the step of providing a second message may include transmitting an Access Accept or equivalent Diameter message from a H-AAA server in the home network to a V-AAA server in the visited network, and relaying the Access Accept or equivalent Diameter message to the mobile device from the visited network. A SUPL start message may be transmitted from the device to the home network at step 710, the SUPL message including serving base station information. At step 712, the address of the V-LS may be determined by transmitting an Access-Request or equivalent Diameter message from the H-LS to an H-AAA server, and transmitting an Access-Accept or equivalent Diameter message from the H-AAA server to the H-LS, the Access-Accept or equivalent Diameter message including information regarding the address of the V-LS. A request using RLP may then be transmitted from the H-LS to the V-LS at step 714, the request including the serving base station information. This request may be a standard roaming location protocol request. A location of the serving base station may be returned from the V-LS to the H-LS in response to the request using RLP at step 716. In one embodiment, assistance data may be provided to the mobile device from the H-LS as a function of the location of the serving base station and a location of the device determined as a function of the assistance data. Furthermore, the location of the mobile device may be determined and the location provided to the mobile device.

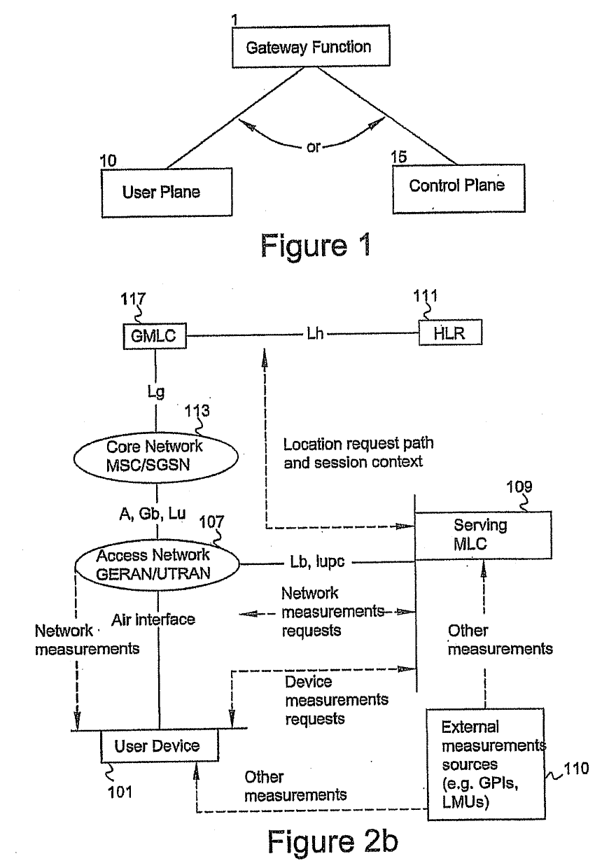

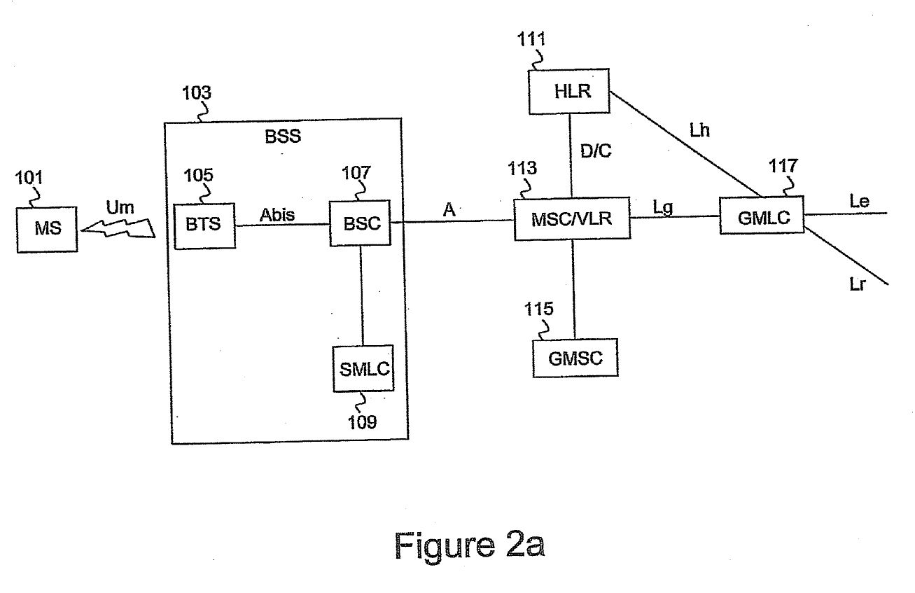

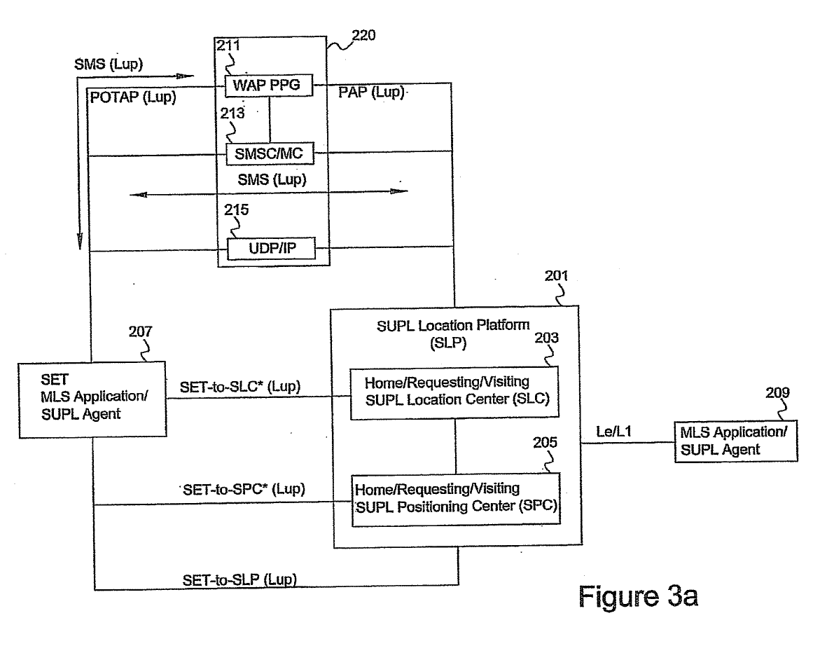

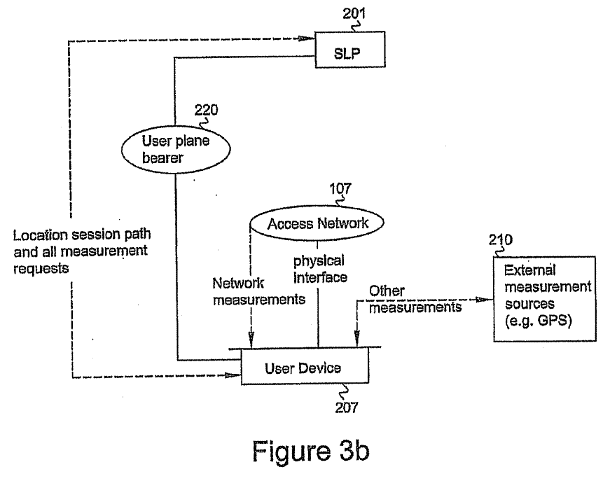

As shown by the various configurations and embodiments illustrated in FIGS. 1-7, a system and method for SUPL roaming in WiMAX networks have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What I claim is:

1. A method for connecting a mobile device to a node in a wireless communications network, comprising the steps of:
(a) receiving a query from a mobile device for a location based application at a visited network, the visited network including a visited location server;
(b) transmitting a first message from the visited network to a home network in response to the query, the first message including information identifying the visited network and the home network including a home location server;
(c) authenticating the first message by the home network;
(d) providing a second message to the mobile device in response to the first message;
(e) transmitting a secure user plane location (“SUPL”) start message from the device to the home network, the SUPL message including serving base station information;
(f) transmitting a request using roaming location protocol (“RLP”) from the home location server to the visited location server, the request including the serving base station information; and
(g) returning a location of the serving base station from the visited location server to the home location server in response to the request using RLP.

2. The method of claim 1 wherein the transmitted request is a standard roaming location protocol request.

3. The method of claim 1 wherein the home network includes a home authentication authorization and accounting (“H-AAA”) server.

4. The method of claim 3 further comprising the step of:
(h) determining the identification of the visited network by:
(i) transmitting an Access-Request or equivalent Diameter message from the home location server to the H-AAA server; and
(ii) transmitting an Access-Accept or equivalent Diameter message from the H-AAA server to the home location server, the Access-Accept or equivalent Diameter message including information regarding the identity of the visited network.

5. The method of claim 1 further comprising the step of caching information in the first message at the home network.

6. The method of claim 1 wherein the wireless communications network is a World Interoperability for Microwave Access (“WiMAX”) communications network.

7. The method of claim 1 wherein the visited network includes a visited authentication authorization and accounting (“V-AAA”) server.

8. The method of claim 1 further comprising the step of:
(h) providing assistance data to the mobile device from the home location server as a function of the location of the serving base station.

9. The method of claim 1 wherein the query is an Access Request or equivalent Diameter message.

10. The method of claim 1 wherein the step of transmitting a message includes identifying the home network as a function a home authentication authorization and accounting (“H-AAA”) server address.

11. The method of claim 1 wherein the mobile device is selected from the group consisting of: cellular device, text messaging device, computer, portable computer, vehicle locating device, vehicle security device, communication device, and wireless transceiver.

12. The method of claim 1 wherein the second message is an Access Accept or equivalent Diameter message.

13. The method of claim 1 wherein the step of providing a second message further comprises:
(i) transmitting an Access Accept or equivalent Diameter message from a home authentication authorization and accounting (“AAA”) server in the home network to a visited AAA server in the visited network; and
(ii) relaying the Access Accept or equivalent Diameter message to the mobile device from the visited network.

14. A method for providing assistance data to a mobile device in a wireless communications network, comprising the steps of:
(a) receiving a query from a mobile device for a location based application at a visited network, the visited network including a visited location server;
(b) transmitting a first message from the visited network to a home network in response to the query, the first message including information identifying the visited network and the home network including a home location server;
(c) authenticating the first message by the home network;
(d) providing a second message to the mobile device in response to the first message;
(e) transmitting a secure user plane location (“SUPL”) start message to the home network, the SUPL message including serving base station information;
(f) determining the address of the visited location server by:
(i) transmitting an Access-Request or equivalent Diameter message from the home location server to a home authentication authorization and accounting (“H-AAA”) server, and
(ii) transmitting an Access-Accept or equivalent Diameter message from the H-AAA server to the home location server, the Access-Accept or equivalent Diameter message including information regarding the address of the visited location server;
(g) transmitting a request from the home location server to the visited location server, the request including serving base station information; and
(h) returning a location of the serving base station to the home location server in response to the request.

15. The method of claim 14 further comprising the steps of:
(i) providing assistance data to the mobile device from the home location server as a function of the location of the serving base station; and
(j) determining the location of the mobile device as a function of the assistance data.

16. The method of claim 14 further comprising the steps of:
(i) determining the location of the mobile device; and
(j) providing the determined location to the mobile device.

17. The method of claim 14 further comprising the step of caching information in the first message at the home network.

18. The method of claim 14 wherein the wireless communications network is a World Interoperability for Microwave Access (“WiMAX”) communications network.

19. The method of claim 14 wherein the visiting network includes a visited authentication authorization and accounting (“V-AAA”) server.

20. The method of claim 14 wherein the query is an Access Request or equivalent Diameter message.

21. The method of claim 14 wherein the step of transmitting a message includes identifying the home network as a function of a home authentication authorization and accounting server address.

22. The method of claim 14 wherein the mobile device is selected from the group consisting of: cellular device, text messaging device, computer, portable computer, vehicle locating device, vehicle security device, communication device, and wireless transceiver.

23. The method of claim 14 wherein the second message is an Access Accept or equivalent Diameter message.

24. The method of claim 14 wherein the request from the home location server is transmitted to the visited location server using roaming location protocol.

25. The method of claim 14 wherein the location of the serving base station is returned to the home location server using roaming location protocol.

26. In a World Interoperability for Microwave Access (“WiMAX”) communications network having a mobile device successfully attached to a visited network, the visited network including a visited location server and being in communication with a home network having a home location server, a method of determining the location of the visited location server by the home location server, comprising the steps of:
(a) transmitting a request using roaming location protocol (“RLP”) from the home location server to the visited location server, the request including information for a base station serving the mobile device; and
(b) returning a location of the serving base station from the visited location server to the home location server in response to the request using RLP.
